(19) United States
(12) Patent Application Publication
(10) Pub. No.: US 2009/0231077 A1
(43) Pub. Date: Sep. 17, 2009

(54) INDUCTOR

(75) Inventors: Wen-Hsiung Liao, Hsin-chu (TW); Yi-Min Huang, Hsin-chu (TW); Roger Hsieh, Hsin-chu (TW); Stanley Chen, Hsin-chu (TW); Yi Tai Chao, Hsin-chu (TW)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: CYNTEC CO., LTD., Hsin-chu (TW)

(21) Appl. No.: 12/116,285

(22) Filed: May 7, 2008

(30) Foreign Application Priority Data
Mar. 17, 2008 (TW) 097109307

(51) Int. Cl. H01F 17/04; H01F 7/06

(52) U.S. Cl. 336/177; 29/606

(57) ABSTRACT

An inductor including a coil and an integrated magnetic body is provided. The integrated magnetic body includes a first magnetic body and a second magnetic body. The coil is disposed within the integrated magnetic body. The first magnetic body has a first magnetic property. The second magnetic body has a second magnetic property. The first magnetic property is different from the second magnetic property.

### BACKGROUND OF THE INVENTION

1. Field of the Invention

The present invention generally relates to a passive electrical component, and more particularly to an inductor.

2. Description of the Prior Art

A conventional method for making an inductor is shown in Japanese patent No. H04-286305. A first powder member and a second powder member are made of the same magnetic powder by a pressure molding process. A hollow coil is positioned between the first powder member and the second powder member and then an integrated inductor is formed by the pressure molding process. However, since the inductor is made of only one kind of the magnetic powder, the inductor properties, such as the inductance, the saturation current, and the direct current resistance, can be adjusted only by one set of parameters (i.e., those of the magnetic powder). As such, the inductor properties are not easily adjusted. Moreover, because the mold for making the powder member has to be produced according to the size of the coil, it causes a higher mold cost.

Another conventional method for making an inductor is shown in U.S. Pat. No. 6,204,744. A powder magnetic material is made of a first iron powder and a second iron powder which are mixed uniformly. A coil and the powder magnetic material are placed within a mold cavity of a pressure molding machine, and then the inductor is formed by a high forming pressure. Because the inductor is not fully supported within the pressure molding machine, the insulating coating of the coil may come away by the high forming pressure. As a result, the inductor may have the problem that the coil is shorted. FIG. 1 compares an inductor made of iron powder and stainless steel powder (Fe—Cr—Si Alloy) which are mixed uniformly according to the conventional method for making an inductor shown in U.S. Pat. No. 6,204,744, with an inductor made of iron powder, and an inductor made of stainless steel powder (Fe—Cr—Si Alloy). The properties of the inductor made of the iron powder and the stainless steel powder are almost the same as the properties of the inductor made of the stainless steel powder. Therefore, by the conventional method for making an inductor shown in U.S. Pat. No. 6,204,744, it is not easy to adjust the inductor's properties, such as the inductance, the saturation current, and the direct current resistance, by the method of mixing two kinds of magnetic powder material uniformly.

### SUMMARY OF THE INVENTION

In one embodiment, the present invention is an inductor. By using a first magnetic body and a second magnetic body which have different magnetic properties and are disposed in different layers, it is capable of increasing the number of parameters for adjusting the inductor properties so as to enable the inductor properties to be adjusted more easily.

The present invention can provide an inductor so as to increase the inductance of the inductor and decrease the cost of making the inductor.

The present invention can provide an inductor, where, for the same inductance, the inductor has a lower direct current resistance and a lower cost of making the inductor.

The present invention can provide an inductor, where, during the pressure molding process, the coil is supported to a greater extent than in the method of U.S. Pat. No. 6,204,744, so as to improve the problem that the coil may be shorted.

In one embodiment, the present invention provides an inductor including a coil and a magnetic body. The magnetic body includes a first magnetic body and a second magnetic body. The coil is disposed within the magnetic body. The first magnetic body has a first magnetic property. The second magnetic body has a second magnetic property. The first magnetic property is different from the second magnetic property.

Other objectives, features, and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 shows the relationship between the current and the inductance for three different conventional inductors;

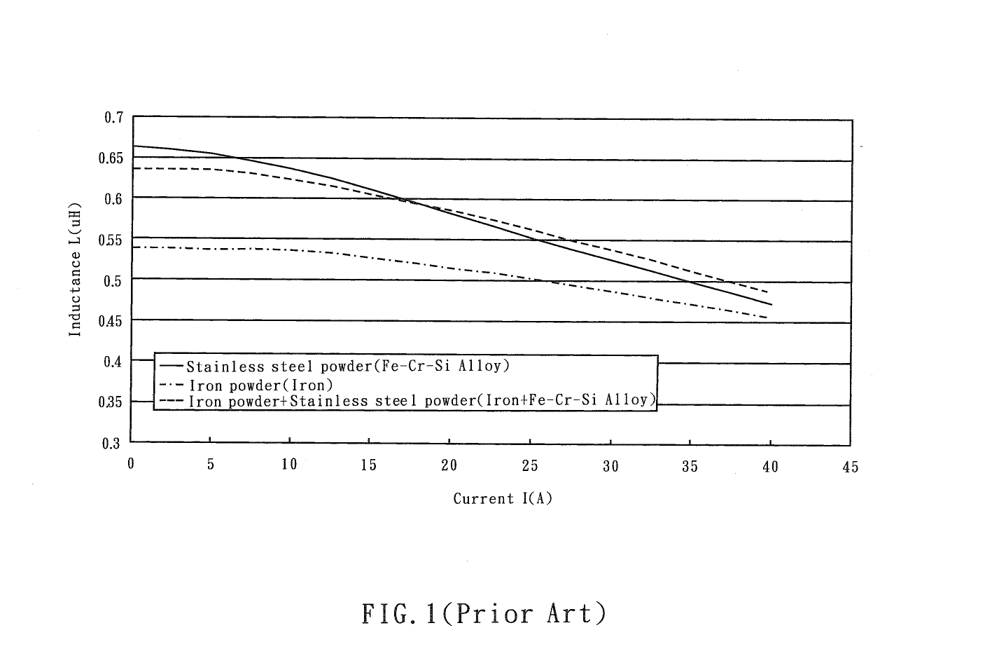

FIG. 2A shows a sectional view of an inductor in accordance with a preferred embodiment of the present invention;

FIG. 2B shows the relationship between the current and the inductance change rate for one possible implementation of the inductor shown in FIG. 2A and two different conventional inductors;

FIGS. 3A, 3C, and 3D show sectional views of inductors in accordance with other preferred embodiments of the present invention;

FIG. 3B shows the relationship between the current and the efficiency for the inductor shown in FIG. 3A and a conventional inductor;

FIG. 4 shows a flow diagram of one possible method for making an inductor of the present invention;

FIG. 5A shows a sectional view of the first magnetic body for the method of FIG. 4;

FIG. 5B shows a top view of the first magnetic body for the method of FIG. 4;

FIG. 5C shows the coil fixed on the first magnetic body for the method of FIG. 4;

FIG. 5D shows the second magnetic body fixed on the coil for the method of FIG. 4;

FIG. 5E shows the first magnetic body and the second magnetic body formed as an integrated magnetic body for the method of FIG. 4;

FIG. 5F shows the formed electrode portion for the method of FIG. 4;

FIG. 6A and FIG. 6B show sectional views of an inductor in accordance with another preferred embodiment of the present invention; and

FIG. 7 shows a top view of the inductor of FIG. 5F indicating that the electrode portion is connected to the coil by a soldering process.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

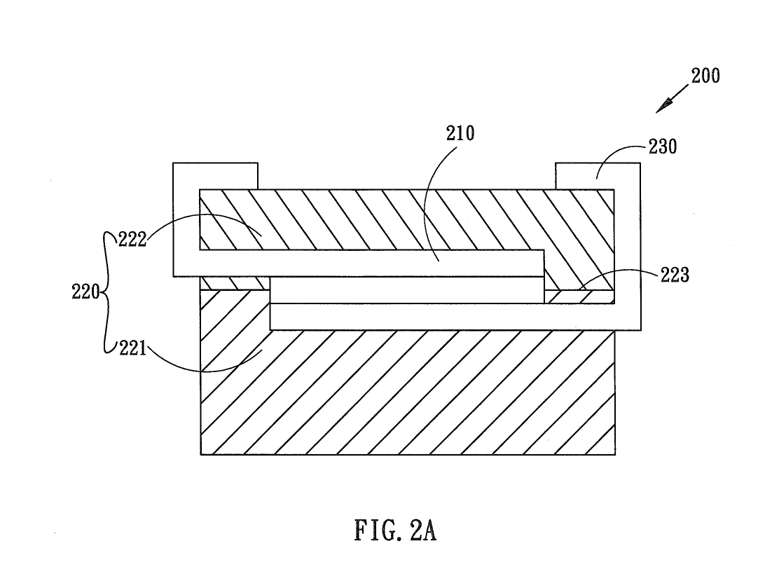

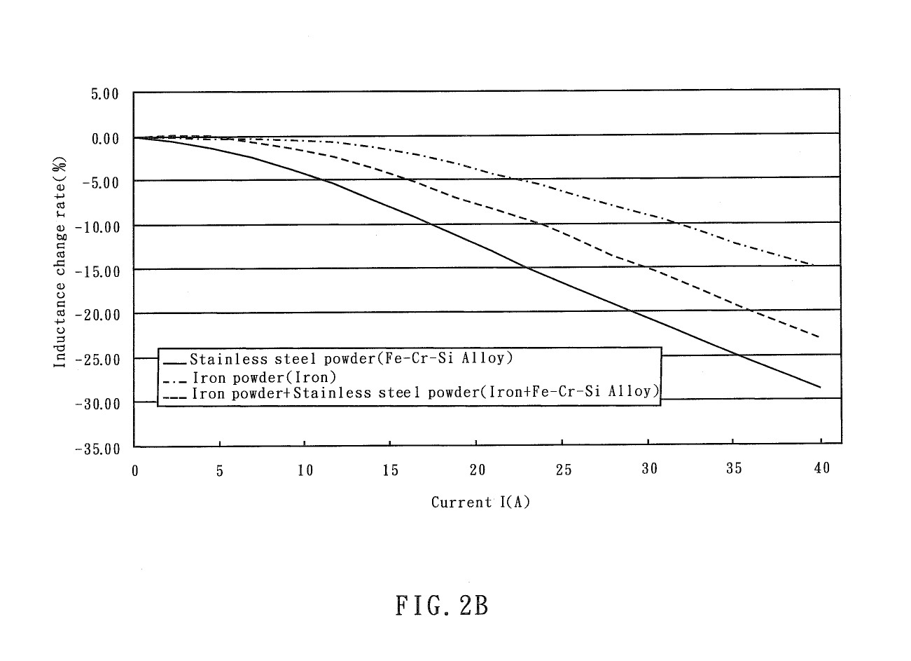

Referring to FIG. 2A, an inductor 200 in accordance with a preferred embodiment of the present invention includes a coil 210, an integrated magnetic body 220, and at least one electrode portion 230. The coil 210 is a hollow coil formed from a metal wire having insulation coating. The metal wire can be a copper wire, although other suitable conducting materials are also possible. The integrated magnetic body 220 includes a first magnetic body 221 and a second magnetic body 222. The coil 210 is disposed within the integrated magnetic body 220. The first magnetic body 221 and the second magnetic body 222 are disposed in different layers. There is an interface 223 between the first magnetic body 221 and the second magnetic body 222. The first magnetic body 221 includes a resin material and a first magnetic powder material; the second magnetic body 222 includes a resin material and a second magnetic powder material. The resin material can be a thermosetting resin, such as epoxy resin, although other suitable materials are also possible. The electrode portion 230 is connected to the coil 210 and extends to the outside of the integrated magnetic body 220, wherein the electrode portion 230 is attached to the second magnetic body 222.

The first magnetic body 221 has a first set of magnetic properties, which includes permeability and saturation current. The permeability is defined as the ratio of the magnetic flux (B) to the magnetic field (H) in the magnetic curve when the magnetic field (H) approaches to zero. The unit of the permeability is in the c.g.s. system. The saturation current is defined as the current when the inductance is decreased to 80% of the inductance when the current is near 0 mA. The second magnetic body 222 has a second set of magnetic properties, which includes permeability and saturation current. At least one of the magnetic properties of the second magnetic body is different from the corresponding magnetic property of the first magnetic body.

Referring to FIG. 2B, the first magnetic body 221 of the inductor 200 of FIG. 2A comprises iron powder and resin material, the second magnetic body 222 of the inductor 200 comprises stainless steel powder (Fe—Cr—Si Alloy) and resin material. The inductor properties of the inductor 200 are compared with (1) the inductor properties of an inductor made of only the iron powder and (2) the inductor properties of an inductor made of only the stainless steel powder (Fe—Cr—Si Alloy). As shown in FIG. 2B, the inductor properties of the inductor 200 are between the inductor properties of the inductor made of only the iron powder and the inductor properties of the inductor made of only the stainless steel powder (Fe—Cr—Si Alloy). Therefore, it is possible to design an inductor having desired inductor properties by adjusting the material properties and/or the volume ratio of the first magnetic body 221 to the second magnetic body 222. Compared to conventional inductors, the number of parameters for adjusting the inductor properties is increased so as to enable the inductor properties to be adjusted more easily.

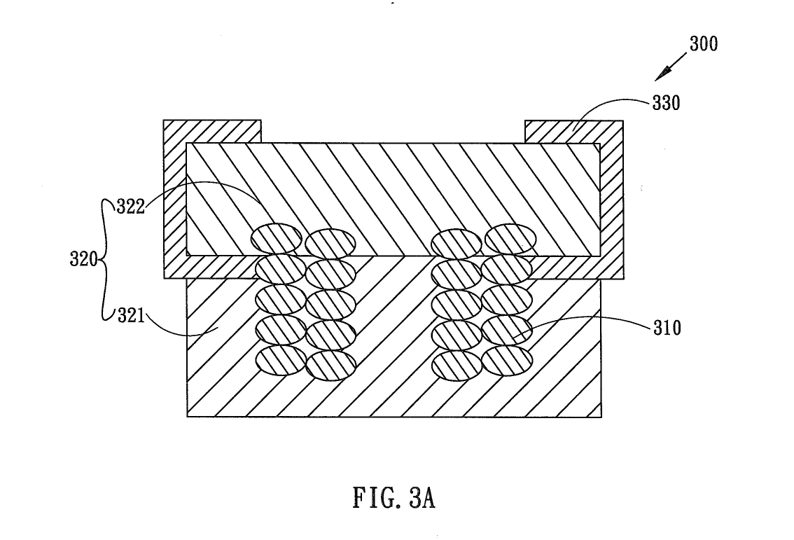

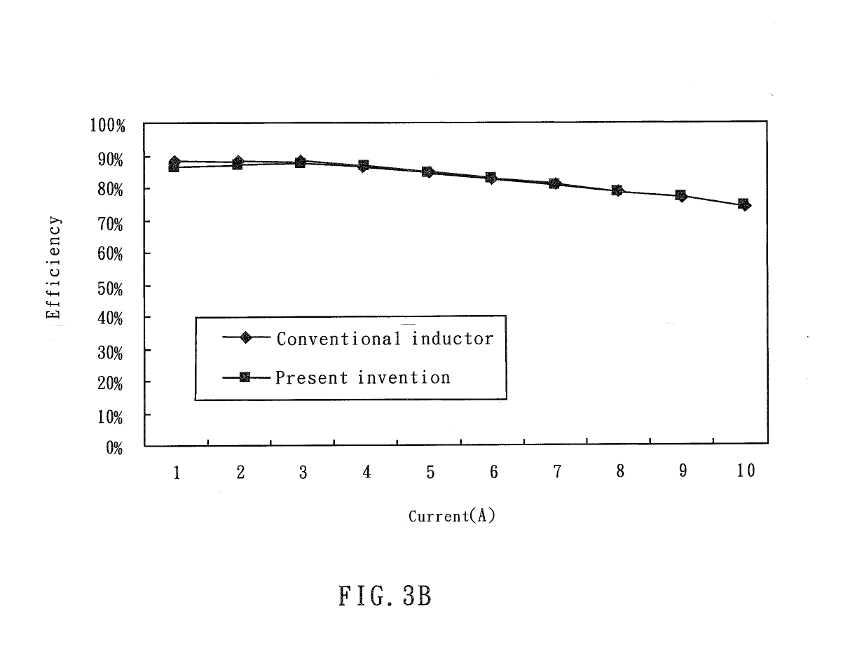

Referring to FIG. 3A, an inductor 300 in accordance with another preferred embodiment of the present invention includes a coil 310, an integrated magnetic body 320, and at least one electrode portion 330. The coil 310 is a hollow coil formed from a metal wire having insulation coating. The integrated magnetic body 320 includes a first magnetic body 321 and a second magnetic body 322. The volume of the first magnetic body 321 is bigger than the volume of the second magnetic body 322. The first magnetic body 321 comprises a first magnetic powder material and a first resin material. The first magnetic body 321 has a first permeability (u1) and a first saturation current (I1). The second magnetic body 322 comprises a second magnetic powder material and a second resin material. The second magnetic body 322 has a second permeability (u2) and a second saturation current (I2). The first permeability (u1) is lower than the second permeability (u2). The first saturation current (I1) is higher than the second saturation current (I2). The ratio of the second permeability (u2) to the first permeability (u1) is higher than 1.25. The ratio of the second saturation current (I2) to the first saturation current (I1) is higher than 0.5. In general, the larger the mean particle diameter (D50) of a magnetic powder material, the higher the permeability. Therefore, in this embodiment, the mean particle diameter of the first magnetic powder material is smaller than the mean particle diameter of the second magnetic powder material.

The coil 310 is disposed within the integrated magnetic body 320. A part of the first magnetic body 321 and a part of the second magnetic body 322 are disposed within a hollow portion of the coil 310, as shown in FIG. 3A. The volume of the first magnetic body 321 disposed within the hollow portion is bigger than the volume of the second magnetic body 322 disposed within the hollow portion. However, it is also possible to dispose a part of only the first magnetic body 421 within the hollow portion of the coil 410, as shown in the embodiment of FIG. 3C.

Referring again to FIG. 3A, the electrode portion 330 is connected to the coil 310 and extends to the outside of the integrated magnetic body 320. In this embodiment, the electrode portion 330 is attached to the second magnetic body 322, while, in the embodiment of FIG. 3D, the electrode portion 480 of inductor 450 is attached to the first magnetic body 471, rather than to the second magnetic body 472. If the permeability of the magnetic material used in the second magnetic bodies (321, 471) is greater than the permeability of the magnetic material used in the first magnetic bodies (322, 472), then the electrode portion 330 of FIG. 3A will have a higher inductance than the electrode portion 480 of FIG. 3D. As a result, the inductor 300 of FIG. 3A will have a higher permeability than the inductor 450 of FIG. 3D, so as to make the inductor 300 have better inductor properties than the inductor 450 of FIG. 3D.

Referring again to FIG. 3A, because the second permeability (u2) of the second magnetic body 322 is higher than the first permeability (u1) of the first magnetic body 321, the inductance of the inductor 300 is increased as compared to a conventional inductor made from a single magnetic powder material having the first permeability (u1). The volume of the first magnetic body 321 is bigger than the volume of the second magnetic body 322. The first permeability (u1) is lower than the second permeability (u2). The first saturation current (I1) is higher than the second saturation current (I2). Therefore, the inductor 300 can be designed such that its properties are the same as the properties of the conventional inductor of U.S. Pat. No. 6,204,744.

The inductor 300 and a conventional inductor made of only a single powder were tested for the same number of turns of the coil, the same saturation current, and the same direct current resistance. The detailed conditions are shown in Table 1; the test results are shown in Table 2.

TABLE 1

| | Turns of | Resin | |
|---|---|---|---|
| Condition | the coil | material | Magnetic powder material |
| Conventional | 7.5 | Epoxy resin | Iron powder: Fe > 98.5% |
| inductor | | | (mean particle diameter is about |
| | | | 4 um) |
| Inductor 300 | 7.5 | Epoxy resin | First magnetic body: |
| | | | Iron powder |
| | | | (Fe > 98.5%; mean particle |
| | | | diameter is about 4 um) |
| | | | Second magnetic body: |
| | | | Stainless steel powder |
| | | | (Fe—9.5Cr—3Si; mean particle |
| | | | diameter is about 20 um) |

TABLE 2

| Condition | Inductance | Cost of magnetic powder material |
|---|---|---|
| Conventional | 1.6 uH | 1 |
| inductor | | |
| Inductor 300 | 1.794 uH | 0.98 |

Referring to Table 1, according to one embodiment of the present invention, the first magnetic powder material is iron powder (Fe>98.5%; mean particle diameter is about 4 um). The second magnetic powder material is stainless steel powder (Fe-9.5Cr-3Si; mean particle diameter is about 20 um). The first resin material and the second resin material are epoxy resin which has a cure temperature of about 120□. The first magnetic body 321 and the second magnetic body 322 are made respectively. Moreover, the volume ratio of the first magnetic body 321 to the second magnetic body 322 is about 1.4-1.6. The first permeability (u1) of the first magnetic body 321 is about 22. The second permeability (u2) of the second magnetic body 322 is about 28. The ratio of the second permeability (u2) to the first permeability (u1) is about 1.25 or higher. The conventional inductor is made of the iron powder (Fe>98.5%) and the epoxy resin. As shown in Table 2, the inductance of the inductor 300 is increased compared to the inductance of the conventional inductor. Because the cost of the stainless steel powder is lower than the cost of the iron powder, the cost of the magnetic powder material for the inductor 300 is reduced.

The inductors of FIGS. 3A and 3C and a conventional inductor made of only a single powder were tested for the same dimension (6.5 mm×6.9 mm×3 mm), the same inductance (1.5 uH), and different volume ratios of the first magnetic body to the second magnetic body. The detailed conditions are shown in Table 3 and Table 5. The test results for the conditions shown in Table 3 are shown in Table 4 and FIG. 3B. The test results for the conditions shown in Table 5 are shown in Table 6.

TABLE 3
Volume ratio of the first magnetic body to the second
magnetic body of about 1.4-1.6

| | Turns of | Resin | |
|---|---|---|---|
| Condition | the coil | material | Magnetic powder material |
| Conventional | 7.5 | Epoxy resin | Iron powder: Fe > 98.5% |
| inductor | | | (mean particle diameter |
| | | | is about 4 um) |
| Inductor 300 | 6.5 | Epoxy resin | First magnetic body: |
| | | | Iron powder |
| | | | (Fe > 98.5%; mean particle |
| | | | diameter is about 4 um) |
| | | | Second magnetic body: |
| | | | Stainless steel powder |
| | | | (Fe—9.5Cr—3Si; mean |
| | | | particle diameter is about |
| | | | 20 um) |

TABLE 4
Test results for the test condition shown in Table 3

| | | Direct | |
|---|---|---|---|
| | | current | Change rate of the |
| | Turns of | resistance | inductance for fixed |
| Condition | the coil | (DCR) | saturation current |
| Conventional | 7.5 | 13.76 mΩ | −15%~−21% |
| inductor | | | |
| Inductor 300 | 6.5 | 12.71 mΩ | −16%~−24% |

TABLE 5
Volume ratio of the first magnetic body to the second
magnetic body of about 2.5-3

| | Turns of | Resin | |
|---|---|---|---|
| Condition | the coil | material | Magnetic powder material |
| Conventional | 7.5 | Epoxy resin | Iron powder: Fe > 98.5% |
| inductor | | | (mean particle diameter is about |
| | | | 4 um) |
| Inductor 400 | 6.5 | Epoxy resin | First magnetic body: |
| | | | Iron powder |
| | | | (Fe > 98.5%; mean particle |
| | | | diameter is about 4 um) |
| | | | Second magnetic body: |
| | | | Stainless steel powder |
| | | | (Fe—9.5Cr—3Si; mean particle |
| | | | diameter is about 20 um) |

TABLE 6
Test results for the test condition shown in Table 5

| | | Direct | |
|---|---|---|---|
| | | current | Change rate of the |
| | Turns of | resistance | inductance for fixed |
| Condition | the coil | (DCR) | saturation current |
| Conventional | 7.5 | 13.76 mΩ | −15%~−21% |
| inductor | | | |
| Inductor 400 | 6.5 | 13.4 mΩ | −15.7~−22.6% |

As shown in Table 4, Table 6, and FIG. 3B, the efficiency of the inductors of the present invention is almost the same as the efficiency of the conventional inductor. Because the inductors of FIGS. 3A and 3C have the second magnetic body, which has a higher permeability, for the same inductance and efficiency, the number of turns of the coil is fewer than in the conventional inductor. Moreover, since the direct current resistance is lower, the heat generated by the inductors of FIGS. 3A and 3C is also lower during use. Both the cost of the coil and the cost of the magnetic powder are reduced. When the volume ratio of the first magnetic body to the second magnetic body is about 1.4-1.6, as shown in FIG. 3A, a part of the first magnetic body 321 and a part of the second magnetic body 322 are both disposed within a hollow portion of the coil 310. The volume of the first magnetic body 321 disposed within the hollow portion is bigger than the volume of the second magnetic body 322 disposed within the hollow portion. When the volume ratio of the first magnetic body to the second magnetic body is about 2.5-3, as shown in FIG. 3C, only a part of the first magnetic body 421 is disposed within a hollow portion of the coil 410 so as to make the inductor 400 have better saturation properties (e.g., a higher saturation current) than the inductor 300 of FIG. 3A.

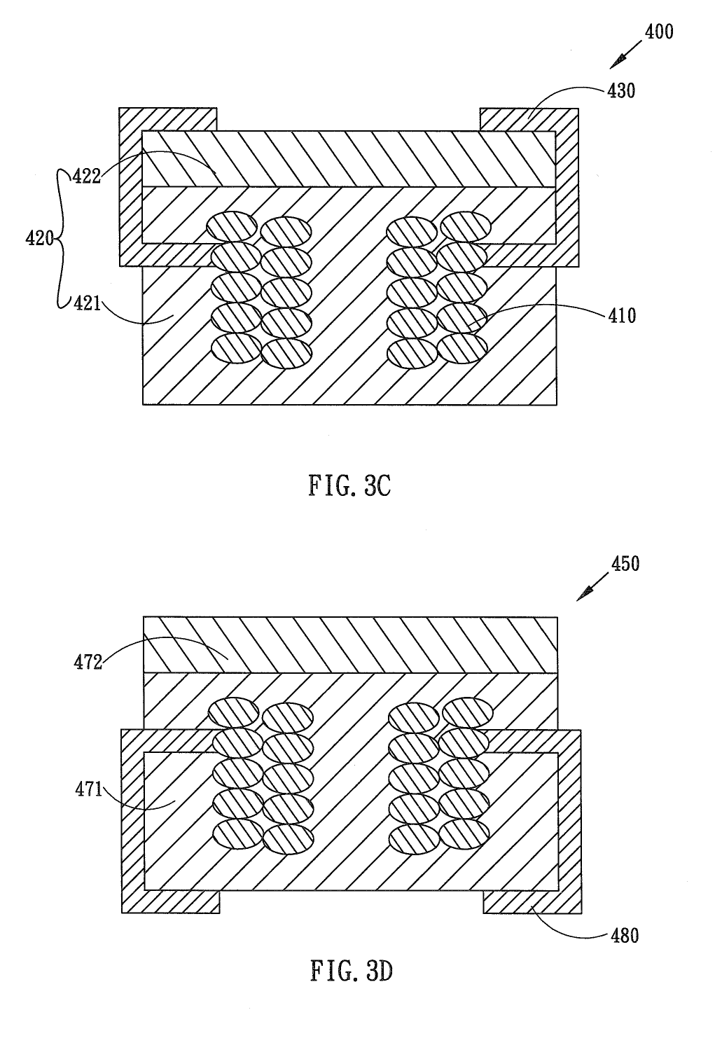

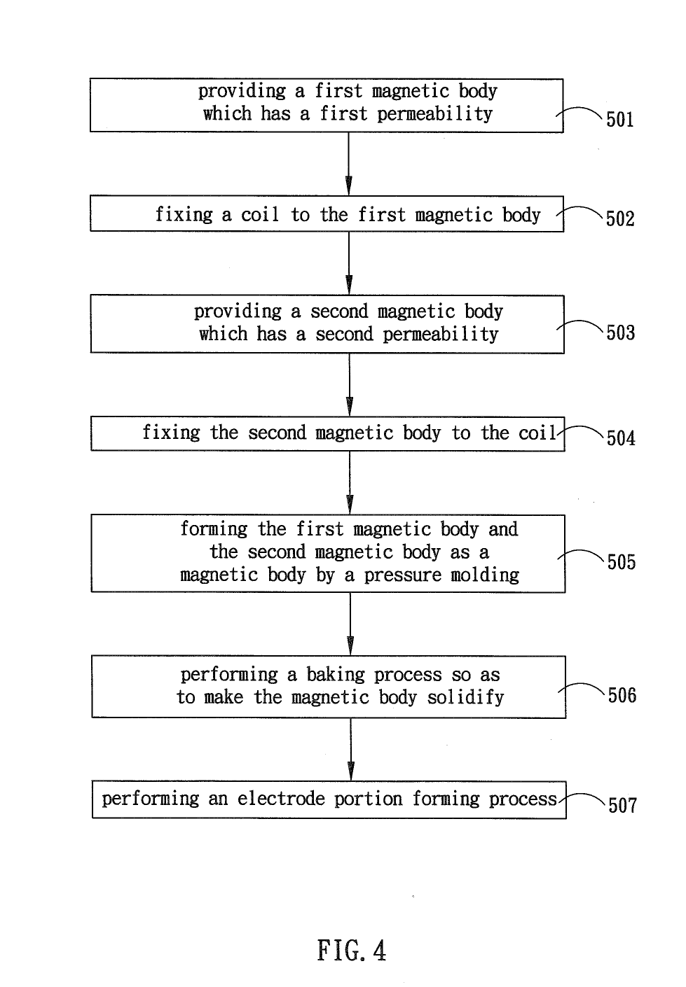

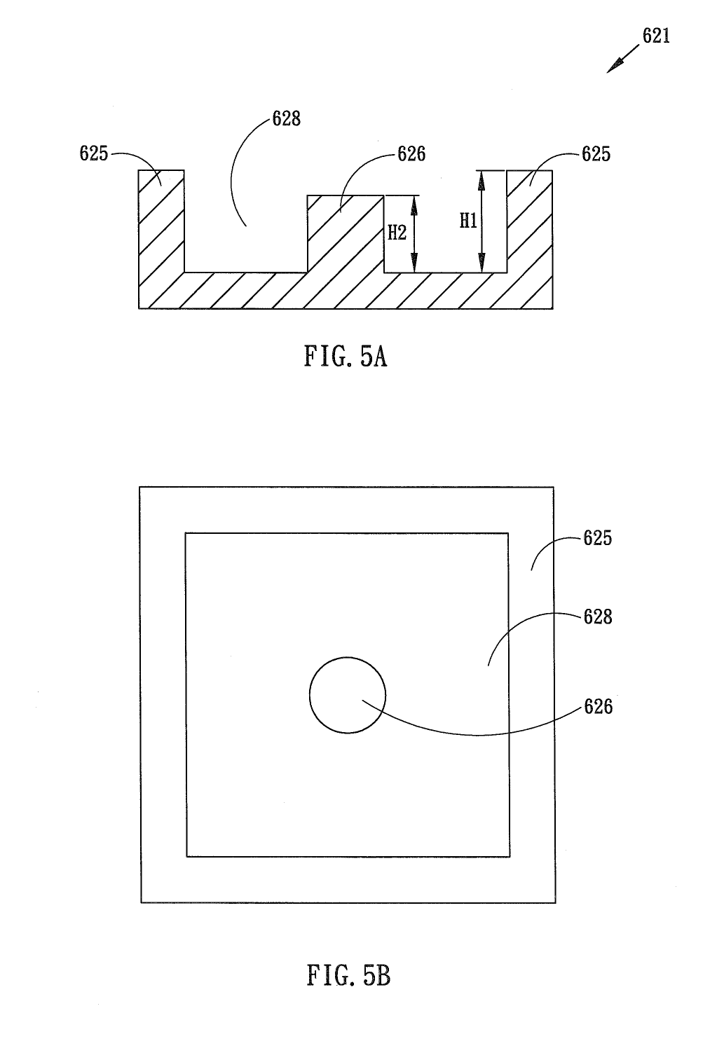

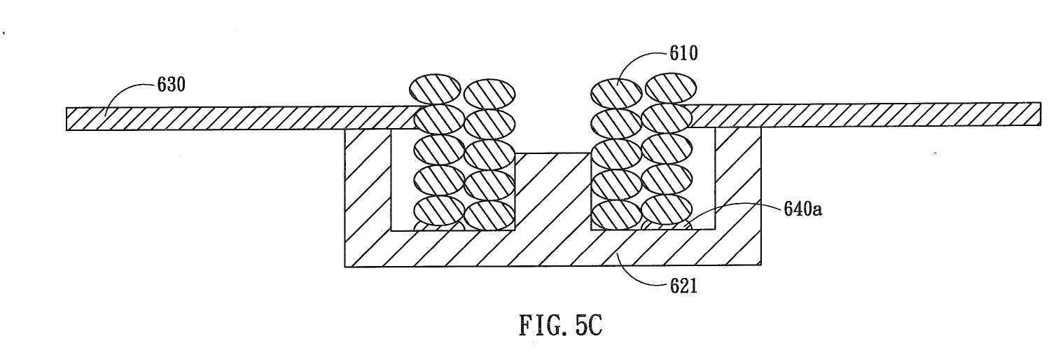

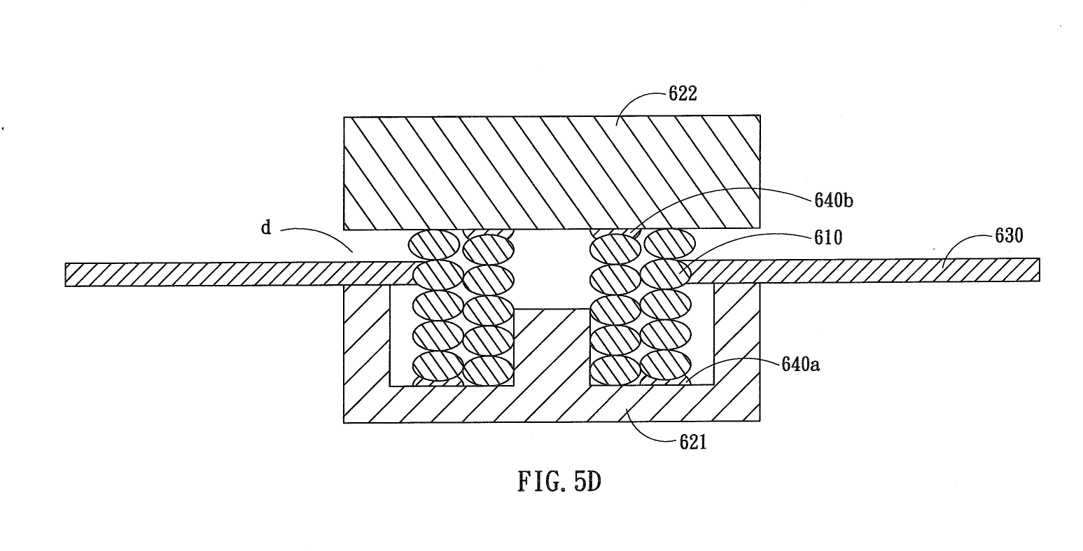

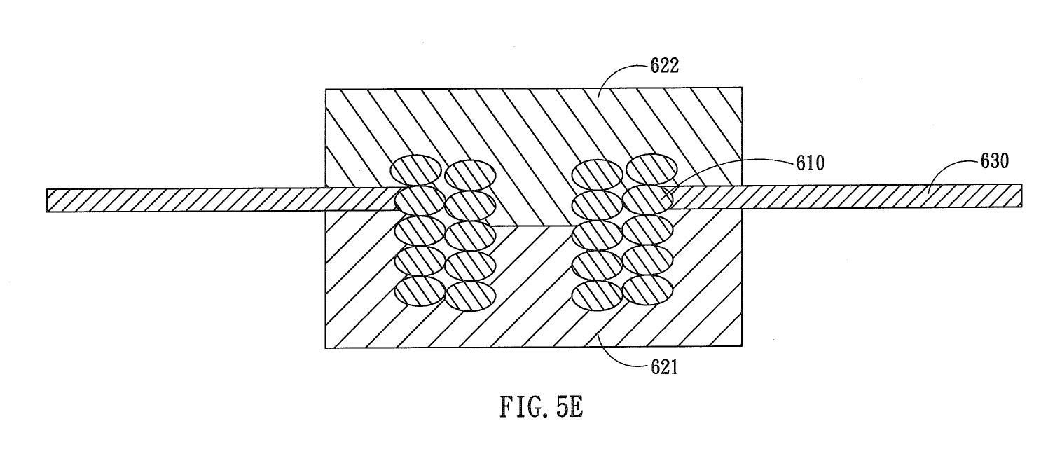

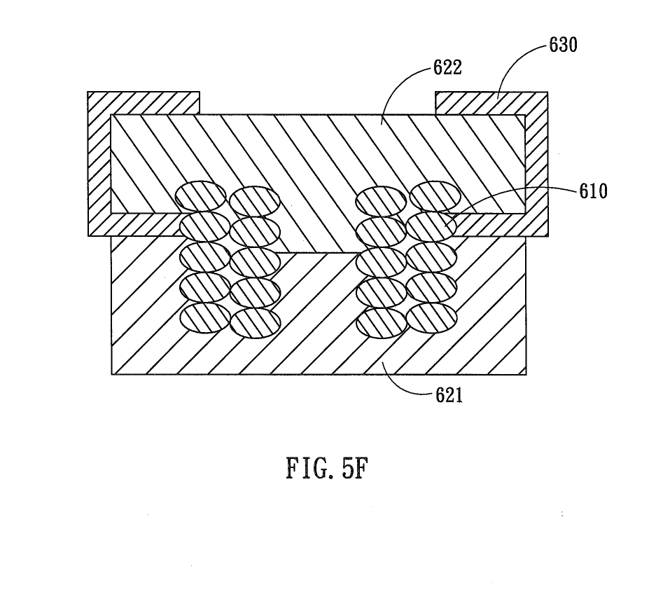

As shown in FIG. 4, the method for making the inductor of FIG. 5F includes providing a first magnetic body 621, which has a first permeability (step 501); fixing a coil 610 to the first magnetic body 621 (step 502); providing a second magnetic body 622 which has a second permeability (step 503); fixing the second magnetic body to the coil 610 (step 504); forming the first magnetic body 621 and the second magnetic body 622 as an integrated magnetic body 620 by a pressure molding process (step 505); performing a baking process so as to solidify the integrated magnetic body 620 (step 506); and performing an electrode portion forming process (step 507).

In the step 501, the first magnetic body 621 comprises a magnetic powder material and a resin material, and the first magnetic body 621 is formed by a pressure molding process, as shown in FIG. 5A and FIG. 5B. The first magnetic body 621 has a section which is substantially in E-shape. The first magnetic body 621 also has an opening 628, whose shape is substantially square, as shown in FIG. 5B. The opening 628 is formed by side walls 625 of the first magnetic body. The opening 628 is larger than the outside diameter of the coil 610. Therefore, it is possible to selectively dispose coils having different sizes within the opening 628. The mold for making the first magnetic body 621 does not have to be produced according to the size of the coil respectively. The first magnetic body 621 has a core 626, which is able to be inserted into the coil 610. Therefore, the coil 610 is supported during the pressure molding process. As a result, the insulation coating of the coil 610 will typically not come away by the high forming pressure of the pressure molding process. Therefore, the problem that the coil 610 may be shorted has been improved. In this embodiment, the height H1 of the side wall 625 is higher than the height H2 of the core 626. The material of the side wall 625 is able to fill up the clearance between the coil 610 and the opening 628, thereby improving the conventional problem that the mold for making the powder member has to be produced according to the size of the coil. As a result, the mold cost can be effectively reduced. In this embodiment, the difference between the height H1 of the side wall 625 and the height H2 of the core 626 is less than 0.5 mm.

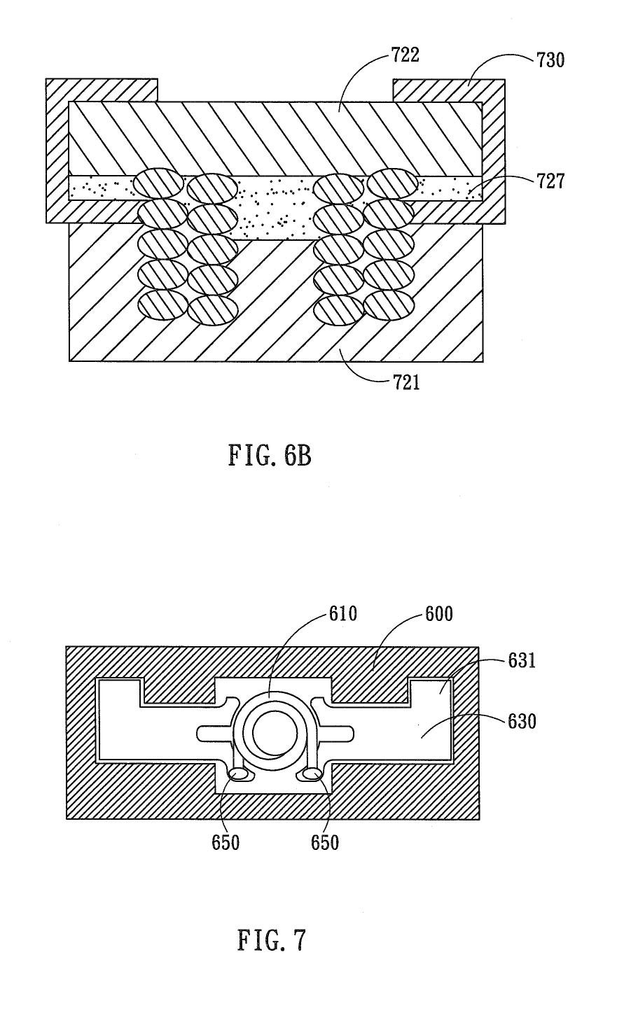

In the step 502, as shown in FIG. 5C, a coil 610 is provided. The coil 610 is a hollow coil formed from a metal wire having insulation coating. The two ends of the coil 610 are pressed to form the electrode portions 630. The electrode portions 630 can also be formed by connecting the coil 610 to a lead frame. As shown in FIG. 7, the electrode portion 630 and the coil 610 can be connected by a laser soldering process to form at least one round solder joint 650 between the electrode portion 630 and the coil 610, so as to improve the problem of the solder joint 650 having a sharp shape that may damage the insulation coating of the coil 610 during the pressure molding process. The electrode portion 630 has a turn portion 631 so as to position the electrode portion 630 to a mold 600, shown in FIG. 7. During the process of fixing the coil 610, a glue member 640a is disposed within the opening 628 of the first magnetic body 621 by a dispensing process, and then the core 626 is inserted into the hollow portion of the coil 610, such that the coil 610 is fixed to the first magnetic body 621 by the glue member 640a. After the coil 610 is fixed, the glue member 640a can be solidified by a baking process. In this embodiment, the material of the glue member 640a is the same resin of the first magnetic body 621 and the second magnetic body 622, although other suitable adhesive materials are also possible.

In the step 503, the second magnetic body 622 comprises a magnetic powder material and a resin material, and the second magnetic body 622 is formed by a pressure molding process. The second permeability of the second magnetic body 622 is different from the first permeability of the first magnetic body 621. The second magnetic body 622 has a section which is substantially in I-shape.

In the step 504, as shown in FIG. 5D, during the process of fixing the second magnetic body 622 to the coil 610, a glue member 640b is disposed on the second magnetic body 622 by a dispensing process. In this embodiment, the material of the glue member 640b is the same resin of the first magnetic body 621 and the second magnetic body 622, although other suitable adhesive materials are possible. And then the second magnetic body 622 is fixed to the coil 610 by the glue member 640b. The first magnetic body 621, the coil 610, and the second magnetic body 622 form a sandwich structure. There is a clearance d between the first magnetic body 621 and the second magnetic body 622. After the second magnetic body 622 is fixed, the glue member 640b can be solidified by a baking process.

In the step 505, as shown in FIG. 5E and FIG. 7, the sandwich structure formed in step 504 is placed within the mold 600. The first magnetic body 621 and the second magnetic body 622 are formed as a single integrated magnetic body 620 by a forming pressure provided by the mold 600. The coil 610 is disposed within the integrated magnetic body 620, and the electrode portion 630 is exposed from the integrated magnetic body 620. The forming pressure is higher than the forming pressure which forms the first magnetic body 621 and the second magnetic body 622. In this embodiment, when the sandwich structure formed in step 504 is placed within the mold 600, the turn portion 631 of the electrode portion 630 is fixed within the mold 600 so as to position the sandwich structure to the mold 600. During the forming process, the electrode portion 630 will not be moved, thereby helping to prevent damage to the insulating coating of the coil 610.

In the step 506, after the first magnetic body 621 and the second magnetic body 622 are formed as an integrated magnetic body 620, the integrated magnetic body 620 can be solidified by a baking process. The temperature of the baking process is higher than the cure temperature of the resin. In this embodiment, the temperature of the baking process is about 150-180□. In the step 507, as shown in FIG. 5F, the electrode portion 630 exposed from the integrated magnetic body 620 is formed by a bending process so as to attach the electrode portion 630 to the second magnetic body 622, thereby finishing the method of making the inductor of FIG. 5F.

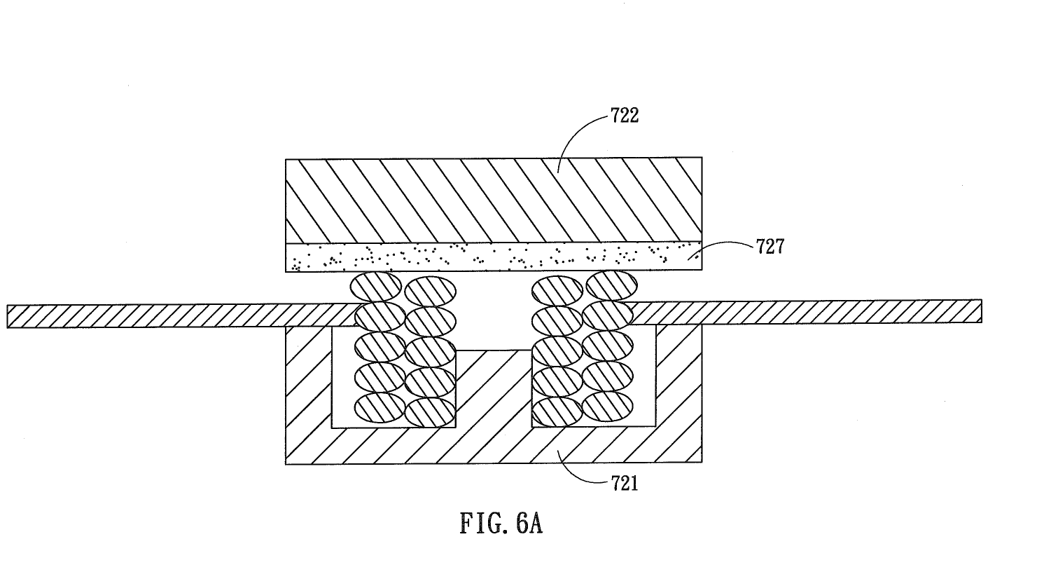

Moreover, when the volume ratio of the first magnetic body and the second magnetic body is higher, such as 2.5-3, it is possible to increase the volume of the first magnetic body and decrease the volume of the second magnetic body. It is also possible use the method shown in FIG. 6A to make an inductor of the present invention. In this embodiment, an additional layer 727 having the same first permeability as the first magnetic body 721 is provided. The additional layer 727 comprises a magnetic powder material and a resin material, and the additional layer 727 is formed by a pressure molding process. Before the second magnetic body 722 is fixed to the coil, the additional layer 727 is fixed to the coil or fixed to the second magnetic body 722. And then the steps 504-507 are performed so as to finish the method of making the inductor of FIG. 6B. Because the E-shaped structure of the first magnetic body is more complicated than the I-shaped structure of the second magnetic body, changing the first magnetic body will typically increase the mold cost. By using the method mentioned above with respect to FIGS. 6A-B, it is possible to change the volume ratio of the first magnetic body and the second magnetic body without changing the structure of the first magnetic body. Therefore, the making cost can be reduced.

Although the present invention has been described in the context of magnetic bodies formed from mixtures of a magnetic powder and a resin, each magnetic body may have additional materials, such as a filler and/or a lubricant.

Although the present invention has been described in the context of inductors having two magnetic bodies with different magnetic properties, the present invention can also be implemented in the context of inductors having more than two magnetic bodies with different magnetic properties.

Although specific embodiments have been illustrated and described, it will be appreciated by those skilled in the art that various modifications may be made without departing from the scope of the present invention, which is intended to be limited solely by the appended claims.

What is claimed is:

1. An inductor comprising:
a coil; and
an integrated magnetic body having a first magnetic body and a second magnetic body, wherein:
the coil is disposed within the integrated magnetic body with at least a portion of the coil extending outside the integrated magnetic body;
the first magnetic body has a first magnetic property;
the second magnetic body has a second magnetic property different from the first magnetic property; and
the first magnetic body and the second magnetic body are disposed in different layers.

2. The inductor of claim 1, wherein a part of the first magnetic body is disposed within a hollow portion of the coil.

3. The inductor of claim 2, wherein a part of the second magnetic body is also disposed within the hollow portion of the coil.

4. The inductor of claim 2, wherein the part of the first magnetic body disposed within the hollow portion of the coil fills the hollow portion of the coil.

5. The inductor of claim 1, wherein permeability of the first magnetic body is different from permeability of the second magnetic body.

6. The inductor of claim 5, wherein a ratio of the permeability of the second magnetic body to the permeability of the first magnetic body is higher than about 1.25.

7. The inductor of claim 1, wherein saturation current of the first magnetic body is different from saturation current of the second magnetic body.

8. The inductor of claim 7, wherein a ratio of the saturation current of the second magnetic body to the saturation current of the first magnetic body is higher than about 0.5.

9. The inductor of claim 1, wherein:
the first magnetic body comprises iron powder and a resin; and
the second magnetic body comprises stainless steel powder and a resin.

10. The inductor of claim 9, wherein the iron powder has a smaller mean particle diameter than the stainless steel powder.

11. The inductor of claim 1, further comprising an additional layer disposed between the first magnetic body and the second magnetic body.

12. The inductor of claim 11, wherein the additional layer and the first magnetic body have a similar material composition.

13. A method for forming an inductor comprising:
(a) forming a first magnetic body;
(b) forming a second magnetic body, wherein a magnetic property of the second magnetic body is different from a corresponding magnetic property of the first magnetic body;
(c) disposing a coil between the first magnetic body and the second magnetic body; and
(d) pressure molding the first and second magnetic bodies into an integrated magnetic body having the coil disposed within, wherein:
at least a portion of the coil extends outside the integrated magnetic body; and
the first magnetic body and the second magnetic body are disposed in different layers.

14. The method of claim 13, wherein:
the first magnetic body has an E-shape;
the second magnetic body has an I-shape; and
step (c) comprises disposing the coil such that a portion of the first magnetic body is disposed within a hollow portion of the coil.

15. The method of claim 14, wherein:
the first and second magnetic bodies are each formed by pressure molding;
pressure applied during the pressure molding of step (d) is greater than pressure applied to form the first and second magnetic bodies such that material from at least the first magnetic body fills in gaps between the coil and the first magnetic body during the pressure molding of step (d).

16. The method of claim 15, wherein material from the second magnetic body fills in gaps between the coil and the second magnetic body during the pressure molding of step (d).

17. The method of claim 14, wherein:
step (c) further comprises disposing an additional I-shaped layer between the first and second magnetic bodies with the coil disposed between the first magnetic body and the additional I-shaped layer; and
step (d) comprises pressure molding the first and second magnetic bodies and the additional I-shaped layer into the integrated magnetic body having the coil disposed within, wherein at least the portion of the coil extends outside the integrated magnetic body.

18. The method of claim 13, wherein permeability of the first magnetic body is different from permeability of the second magnetic body.

19. The method of claim 13, wherein saturation current of the first magnetic body is different from saturation current of the second magnetic body.

20. The method of claim 13, wherein:
the first magnetic body comprises iron powder and a resin; and
the second magnetic body comprises stainless steel powder and a resin.

21. The method of claim 13, wherein step (c) further comprises gluing the coil to at least the first magnetic body.
